(19) United States
(12) Patent Application Publication
(10) Pub. No.: US 2005/0210830 A1
(43) Pub. Date: Sep. 29, 2005

(54) Channel type frame adapter

(76) Inventors: Anthony Brian Lee, Ramona, CA (US); Jessica Anne Lee, Ramona, CA (US)

Correspondence Address: Anthony Brian Lee, 19726 Casner Road, Ramona, CA, 92065, US

(21) Appl. No.: 10/807,802

(22) Filed: Mar. 24, 2004

(51) Int. Cl. E06B 3/00; E04B 7/00

(52) U.S. Cl. 52/800.12; 52/272; 52/208

(57) ABSTRACT

The channel type frame adapter is an adapter which allows or facilitates the installation of a pane, panel, multiple paned or multiple paneled unit into a channel type frame which was made to accommodate a pane, panel, multiple paned or multiple paneled unit of the same or another thickness or size.

### BACKGROUND OF THE INVENTION

When it becomes necessary to install another paned or paneled unit within an opening which was built or manufactured to specific dimensions, several problems invariably arise which require substantial time, inconvenience and cost to overcome. If, for example, one wanted to install a newer, more energy efficient window pane or multi-paned unit in an existing location, it is necessary first to purchase a complete, new window unit. Then, there is the demolition of interior and exterior wall materials along with the resizing of the opening and finally, the reconstruction of the materials around the newly installed window unit to match those which were demolished. Suddenly, a simple energy efficiency upgrade has become an enormous expense and inconvenience. The same is true when replacing any paned or paneled unit within any frame or fixed frame. Currently, the frame must be removed and discarded and/or replaced with a new frame which is designed to encase the new paned or paneled unit.

### BRIEF SUMMARY OF THE INVENTION

The channel type frame adapter substantially reduces the amount of labor and materials currently required in order to replace a pane or panel thus, greatly reducing the time and cost involved. An existing frame, with the aid of the channel type frame adapter, can now be used to encase and install the newly desired paned or paneled unit. The installation of new panes or panels using the channel type frame adapter is simple enough that it can be performed by persons with minimal construction skills and requires no specialized tools to accomplish.

### BRIEF DESCRIPTION OF THE SEVERAL VIEWS OF THE DRAWING

FIG. 1. End view

FIG. 2. End View

FIG. 3. Side view

FIG. 4. End view

FIG. 5. End view

FIG. 6. End view

### DETAILED DESCRIPTION OF THE INVENTION

An adapter which allows or facillitates the installation of a pane, panel, multiple paned or multiple panelled unit into a channel type frame which was designed of manufactured to accomodate a pane, panel, multiple paned or multiple panelled unit of the same or another thickness or size.

The adapter is designed to encase a pane, panel, multiple paned or multiple panelled unit and be inserted into a frame. The adapter may be composed of natural or manmade materials or any combination thereof. The adapter may be formed as a single piece or as a multiple pieced unit by any of a variety of manufacturing techniques. The adapter may be self sealing or used in conjunction with sealing materials available for that application. That portion of the adapter which is identified in the drawings as dimensions C and D is designed to encase the newly desired material, while another portion of the adapter, shown in the drawings as dimensions A and B, is designed to be inserted into a frame. The size and dimensions of the adapter will vary in order to accomodate the desired application or the requirements of industry standards. The height, width, length, depth or thickness of any or all dimensions of the adapter may vary as required to accomodate the parameters dictated by the dimensions of the new paned or panelled unit to be installed and/or the dimensions of the existing components into which said unit will be installed. Variations may include but, are not limited to the following examples:

Dimension A may vary to accommodate existing channel depths.

Dimension B may vary to accommodate existing channel widths.

Dimension C may vary to accommodate the thickness of new paned or panelled units to be installed.

Dimension D may vary to accommodate dimensional or engineering requirements of the new paned or panelled unit to be installed. Any and/or all of the dimensions of the adapter may vary to further accommodate the dimensions of a separate seal which may be used in conjunction with the adapter.

The portion of the adapter which is identified with the dimensions A and B may be centered in the adapter or offset in order to accommodate various applications or requirements.

That portion of the adapter which is identified as dimension B may be wider than that portion of the adapter which is identified as dimension C.

The horizontal plane in FIG. 2 which divides dimensions B and C may be extended beyond either or both sides of dimension C as required to accommodate application specifications. The extension of this horizontal plane is indicated in FIG. 2 with the use of broken lines. The arrows in FIG. 2 indicate an unspecified range along the horizontal plane to which parts or portions of the adapter may be attached.

A length of channel adapter as illustrated in FIG. 3 may be manufactured to standard lengths or manufactured in unspecified lengths which may be cut to the desired length by the user.

It is not the intention that the drawings included with this specification should serve to illustrate each and every configuration of the adapter, as, that would be impossible.

Rather, it is the intention of the inventors that these drawings should, with respect to the written text within this specification provide a clear understanding regarding the range of form, configuration or variation of the adapter.

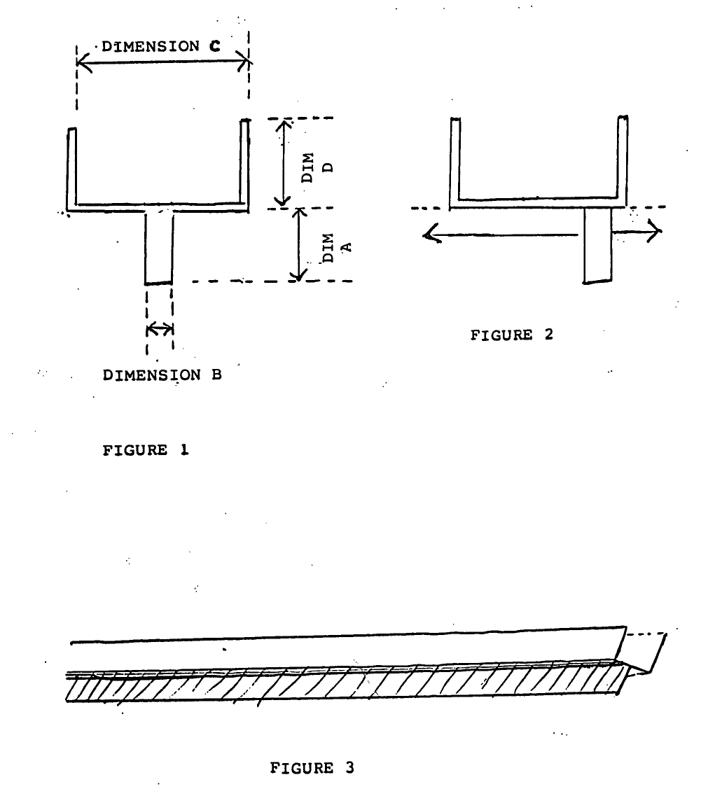

FIG. 1. End view which illustrates variations of the adapter. This drawing serves also to identify the dimensions of the adapter with the designations A, B, C and D. The dimensions in FIGS. 2 thru 6: are identifiable in the same manner as that set forth in FIG. 1.

FIG. 2. End view which illustrates variations of the adapter. This drawing illustrates, with the use of broken lines and arrows, a horizontal plane of undetermined length, along which parts or portions or the adapter may connect or intersect.

FIG. 3. Side view which illustrates an unspecified length of the channel adapter, wherein the configuration matches that of FIG. 1.

FIG. 4. End view which illustrates variations of the adapter. This drawing illustrates horizontal planes with the aid of broken lines. These horizontal planes are identified with the letters X, Y and Z. FIG. 4 illustrates variations of the adapter, among others, wherein parts of the adapter may be connected along one or more of the horizontal planes identified as X, Y and Z. In the absence of any connection between the parts as illustrated in FIG. 4, the adapter exists as a two piece adapter. The horizontal planes as identified in FIG. 4 shall serve to identify the existence of horizontal planes in FIGS. 1,2,3,5 and 6 perspectively and are identifiable with the same letter designations as set forth for the horizontal planes in FIG. 4.

The horizontal planes which have been identified previously are not intended to exclude connections between parts of the adapter along other horizontal, diagonal or radial planes which exist at all points between those planes previously identified as X, Y and Z and which exist as points at which parts of the adapter may be connected.

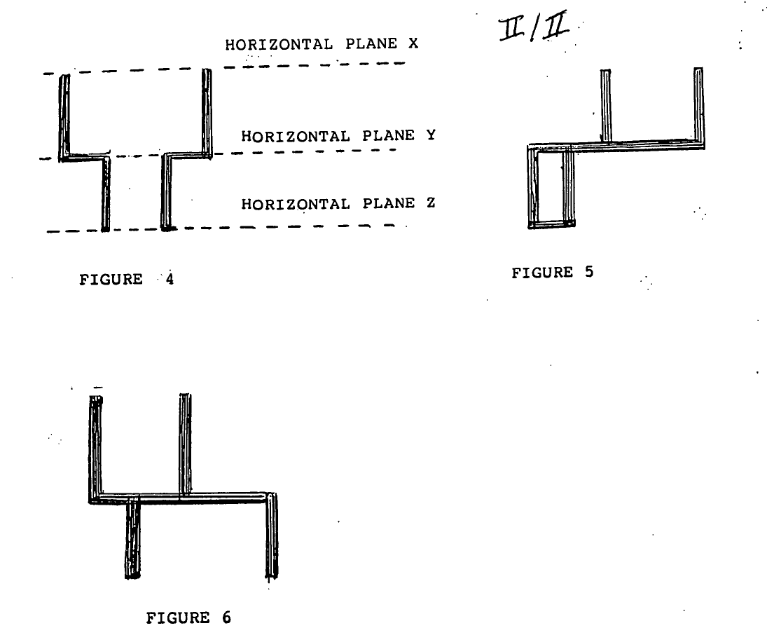

FIG. 5. End view which illustrates variations of the adapter.

FIG. 6. End view which illustrates variations of the adapter. One of the variations depicted in FIG. 6 is the potential for the parts of the adapter with regard to function as previously defined to be interchangeable or reversible. Whereas dimensions A and B were previously described as that portion of the adapter which would be inserted into a frame and whereas, dimensions C and D were described as that portion of the adapter designed to encase a pane, panel, multi-paned or multi-panelled unit, The reversal of function can be illustrated by inverting the drawing on it's horizontal axis.

Parts of the adapter may form angles which are greater or less than 90 degrees in order to create a tensioned fit over materials intended for encasement within the adapter or to create a tensioned fit for that portion of the adapter which is designed to be inserted into a frame.

Parts of the adapter may be formed with bends or curves in order to create a tensioned fit over materials intended for encasement within the adapter or to create a tensioned fit for that portion of the adapter which is designed to be inserted into a frame.

Parts of the adapter may be formed with bends or curves to facilitate the fitting of materials into the adapter or to facilitate the fitting of the adapter into a frame.

Parts of the adapter may slide or be otherwise adjustable in order for the adapter to frame a new pane, panel, multi paned or multi paneled unit and be installed into a frame which can not be removed, moved or taken apart.

1. A channel type frame adapter which allows or facilitates the installation of a pane, panel, multiple paned or multiple paneled unit into a frame which was made to accommodate a pane, panel, multiple paned or multiple paneled unit of the same or another thickness or size.

2. An adapter in accordance with claim 1 wherein, it is designed to encase the perimeter or edge of a pane, panel, multiple paned or multiple paneled unit and which is designed to be inserted into a frame.

3. An adapter in accordance with claim 1 wherein, it is made of a rigid material.

4. An adapter in accordance with claim 1 wherein, it is made of a flexible material.

5. An adapter in accordance with claim 1 wherein, it is made with a part which is manufactured of a material which is suitable for the purpose of sealing, protecting or cushioning the material which is to be inserted into the adapter.

6. An adapter in accordance with claim 1 wherein, it is made to be used in conjunction with a separate seal available for that purpose.

7. An adapter in accordance with claim 1 wherein, the height, width, depth, thickness or length of any dimension or part may vary in order to accommodate the desired application.

8. An adapter in accordance with claim 1 wherein, the parts of the adapter form 90 degree angles.

9. An adapter in accordance with claim 1 wherein, the parts of the adapter form angles which are greater or less than 90 degrees.

10. An adapter in accordance with claim 1 wherein, parts of the adapter are formed with angles, bends or curves.

11. An adapter in accordance with claim 1 wherein, parts of the adapter are formed in such a manner as to create a catch when inserted into a frame.

12. An adapter in accordance with claim 1 wherein, it is made as a single or multiple piece adapter.

13. An adapter in accordance with claim 1 wherein, a part or parts of the adapter are adjustable.
